(19) United States
(12) Patent Application Publication
(10) Pub. No.: US 2006/0031129 A1
(43) Pub. Date: Feb. 9, 2006

(54) Apparatus and method for processing transaction information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 11/230,780

(22) Filed: Sep. 20, 2005

Related U.S. Application Data
(63) Continuation of application No. 09/987,237, filed on Nov. 14, 2001.
(60) Provisional application No. 60/250,076, filed on Nov. 30, 2000.

(51) Int. Cl. G06Q 30/00

(52) U.S. Cl. 705/26

(57) ABSTRACT

An apparatus and method for processing a transaction, including a memory device for storing information regarding at least one of a good, a product, a service, a security, a stock, a bond, a commodity, a derivative, and information for processing a transaction, a receiver for receiving an information request from a communication device associated with a user for information regarding the at least one of a good, a product, a service, a security, a stock, a bond, a commodity, a derivative, and a transaction involving same, a processor for processing the information request in conjunction with the information stored in the memory device, wherein the processor generates a report containing information in response to the information request, wherein the information report contains video information, and a transmitter for transmitting the information report to the communication device associated with the user.

### RELATED APPLICATIONS

This application claims the benefit of priority of U.S. Provisional Patent Application Ser. No. 60/250,076, filed Nov. 30, 2000, and entitled “APPARATUS AND METHOD FOR PROCESSING TRANSACTION INFORMATION”, the subject matter of which is hereby incorporated by reference herein.

### FIELD OF THE INVENTION

The present invention pertains to an apparatus and method for processing transaction information and, in particular, to an apparatus and method for processing transaction information in a network environment.

### BACKGROUND OF THE INVENTION

The explosive growth in usage and acceptance of the Internet and/or the World Wide Web, as a platform by which to conduct transactions, will undoubtedly create a continued demand for providing multimedia information in an on-line environment. Likewise, the continued growth in usage and acceptance of cellular telephones, personal digital assistants, and wireless devices, will also create a continued demand to provide information, including multimedia information in a wireless devices.

Prior art systems are known which facilitate transactions via centralized computers or so-call interactive mailbox facilities. These prior art systems appear to rely on the use of electronic mail or e-mail messages which are transmitted by, from, and/or between, the respective parties to transactions. As is well known, however, e-mail messages are not typically real-time communications. As such, the ability to conduct transactions in real-time can be seriously compromised.

Another drawback with the above-described prior art systems is that they appear to require that transactions be processed by or via a centralized computer system. As one can readily appreciate, processing transactions through an intermediary system or computer can require additional and sometimes unnecessary communications and time delays. Moreover, an individual or user would not necessarily be in contact with, and/or in direct communication with, the counterparty to the transaction, thereby depriving the individual or user of a personal or one-on-one communication with the respective counterparty, vendor, or merchant.

### SUMMARY OF THE INVENTION

The present invention pertains to an apparatus and method for processing transaction information which overcomes the shortfalls of the prior art. The present invention pertains to an apparatus and method for processing transaction information and in particular to an apparatus and method for processing transaction information in a network environment.

The apparatus and method of the present invention can be utilized to process a transaction in any communication network environment, in a wireless communication network, in a line-wired communication network, and/or in any combination of wireless and wired networks. The present invention can also be utilized in conjunction with the Internet and/or the World Wide Web.

The present invention can be utilized for facilitating commerce involving wireless communication, wired communications, and/or mobile commerce (M-commerce).

The present invention can be utilized in facilitating and/or effectuating commerce in or regarding any goods, products, and/or services, which can be the subject matter of a transaction and/or a commercial transaction. The apparatus and method of the present invention can also be utilized in conducting financial transactions and/or investment transactions involving securities, stocks, bonds, commodities, and/or any financial and/or commodities derivatives, options, futures, forwards, and/or other contracts.

The apparatus can include any one or more vendor computer(s) or merchant computer(s). The vendor computer(s) or merchant computer(s) can be associated with any one or any number of vendors or merchants for facilitating the sale or trade of any of the goods, products, and/or services, described herein as being sold and/or traded via the apparatus and method of the present invention.

The vendor computer(s) or merchant computer(s) can be any computer or computer system for processing transaction information regarding transactions involving and/or related to any of the goods, products, and/or services, described herein as being sold or traded via the apparatus and method of the present invention. The vendor computer(s) or merchant computer(s) can also be any suitable computer, network computer, server computer, computer system, or communication device, for providing any of the transaction processing and/or functionality described herein.

The apparatus can also include any number of central processing computer(s) or server computer(s). The central processing computer(s) can provide control over the apparatus and can perform various processing operations for providing any of the various services described herein. The central processing computer can also provide various services and/or functionality for or regarding any of the vendors, merchants, or users of the apparatus and method of the present invention.

The central processing computer(s) can be any suitable computer, network computer, computer system, or communication device, for providing service for the various vendors, merchants and/or users of the apparatus and method of the present invention and/or any of the respective computers and/or communication devices associated therewith.

The apparatus can also include one or more user computers or user communication. Each user communication device can be associated with a user, individual, or group of users or individuals. The user communication device can be utilized by any user, individual, vendor, merchant, and/or any other third party desiring to utilize the apparatus of the present invention.

Each user communication device can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the user communication device to communicate with and/or to interact with any of the vendor computer(s) or merchant computer(s), the central processing computer(s), and/or any of the user computers or user communication devices described herein. Each user computer or communication device can be utilized to transmit information to, and receive information from, any of the vendor computer(s) or merchant computer(s), central processing computers, and/or any other user computers or user communication devices described herein.

Each of the vendor computer(s) or merchant computer(s), the central processing computer(s), and/or the user computer(s) or user communication device(s), can communicate and/or interact with any vendor computer(s) or merchant computers, the central processing computer(s), and/or the user computer(s) or user communication devices.

The vendor computer(s) or merchant computers, the central processing computer(s), and/or the user computer(s) or user communication device(s), can communicate with each other via any suitable communication network or system.

The apparatus of the present invention can be utilized on or over any communication network or system, any telecommunication network or system, any wireless communication network or system, Internet and/or the World Wide Web, and/or any other communication network or system, and/or any combination of the above.

The present invention can utilize, and/or can be utilized in conjunction with, wireless Internet and/or World Wide Web services, equipment and/or devices.

Any of the computer to computer communications, and/or any of the communications which can occur between any of the herein-described individuals and/or entities and/or their respective computers or communication devices, can be made and/or can be effected by an e-mail transmission, an e-mail message, an instant messaging transmission, an electronic transmission, a telephone message, a letter mail delivery, a telephone transmission, a facsimile transmission, a beeper or a pager message, and/or via any other notification means or method. Any and/or all of the communications which can occur between any of the herein-described computers and/or the individuals and/or entities associated therewith can contain text information, video information, audio information, audio/video information, and/or any combination of same.

The apparatus and method of the present invention can be utilized in order to conduct transactions in a network environment. The transactions can involve any goods, products, or services, which can be the subject matter of commerce. The apparatus and method of the present invention can also be utilized in order conduct can also be utilized in conducting financial transactions and/or investment transactions involving securities, stocks, bonds, commodities, and/or any financial and/or commodities derivatives, options, futures, forwards, and/or other contracts.

A user can access the vendor computer or merchant computer via his or her user computer or user communication device. The user can enter information regarding the respective good(s), product(s), and/or service(s), which the user desires to either purchase, lease, and/or otherwise obtain, and transmit to entered information to a vendor computer or merchant computer.

The respective vendor computer or merchant computer can receive and process the information obtained from the user and transmit information regarding the requested good(s), product(s), and/or service(s) to the user computer or user communication device associated with the user.

The information can include any one or more of a description of the respective good(s), product(s), and/or service(s), a price or prices for the respective good(s), product(s), and/or service(s), a video image(s) or video clip of or regarding the respective good(s), product(s), and/or service(s), audio information for or regarding the respective good(s), product(s), and/or service(s), and/or any applicable shipping, handling, and/or delivery, information and/or charges or costs.

The information can also include any other data and/or information which can be related to the respective good(s), product(s), and/or service(s), and/or information regarding any transactions involving any of the respective good(s), product(s), and/or service(s), or prospective transactions which may involve any of the respective good(s), product(s), and/or service(s).

The user can enter into a transaction involving the respective good(s), product(s), and/or service(s). The respective vendor computer or merchant computer can thereafter process and/or consummate the transaction for the user. The vendor computer can also generate a transaction confirmation message which can contain information regarding the transaction which has taken place.

The transaction confirmation message can also contain details regarding the transaction, the amount(s) or total amount of the transaction, delivery and/or shipment information, and information regarding any due balance(s). The transaction confirmation message can be any one or more of an e-mail message, an instant messaging service message, a telephone call, a telephone call with a pre-recorded message, a beeper message, a pager message, a facsimile message, an instant messaging message, and/or any other appropriate message, electronic message, and/or electronic transmission.

The vendor computer(s) or merchant computer(s) can transmit any of the herein-described e-mail messages, the instant messaging services messages, the telephone calls, the telephone calls with a pre-recorded message, the beeper messages, the pager messages, the facsimile messages, and/or any other appropriate messages, electronic messages, and/or electronic transmissions, to the user computer(s) or user communication device(s).

The vendor computer(s) or merchant computer(s) can also notify a user that any one or more of the herein-described e-mail messages, instant messaging services messages, telephone calls, telephone calls with a pre-recorded message, beeper messages, pager messages, facsimile messages, and/or any other appropriate messages, electronic messages, and/or electronic transmissions, has been sent to the user.

The transaction confirmation message can contain links or hyperlinks for enabling the user to interact with any of the herein-described messages and/or the respective senders.

At any time during the operation of present invention, the user can utilize the respective user communication device in order to communicate with a vendor's representative, in real-time. The user can also communicate with the vendor by leaving a voice mail message for the vendor or a vendor's representative via the video telephone or videophone. The vendor or the vendor's representative can then call the user back in response to the message.

The apparatus and method of the present invention can allow a user to communicate with the vendor in order to obtain information and/or customer service information from the vendor.

The apparatus and/or the vendor computer can store all information regarding the information request and/or information regarding the transaction in progress until such time as the vendor or the vendor's representative can return the user's call or respond to the user's message. The vendor's representative can then call the user back at the user communication device and have all of the information to-date regarding the transaction, and/or the transaction in progress, available in order to facilitate picking-up the transaction at the point where the user needed or requested the information.

The vendor computer(s) or merchant computer(s) can also record and store any information regarding any of the transactions which can be facilitated by the apparatus and method of the present invention for later use by the respective vendor(s) or merchant(s) in their respective marketing activities, advertisement and promotional activities, and/or for any other appropriate purpose(s).

The vendor computer(s) or merchant computer(s) can also function as an interactive message handling facility for processing and storing any messages, e-mail messages, instant messaging services messages, and/or any other electronic and/or other messages or transmissions, which can be utilized in order to facilitate communications by and between any of the herein described users or vendors. The vendor computer(s) or merchant computer(s) can also function as an interactive mailbox facility for any of the messages sent between any of the respective parties.

The vendor computer(s) or merchant computer(s) can contain the hardware and software needed for providing an interactive message handling facility and/or an interactive mailbox facility. The vendor computer(s) or merchant computer(s) can also include, and/or be linked to, any other computer, computer system, server computer, e-mail server computer, and/or message server computer, in order to provide the herein-described message handling facility and/or interactive mailbox facility.

Any of the herein described communications, transmissions and/or messages, can be transmitted or received via the central processing computer which can serve as an intermediary between the respective parties. The central processing computer can also function as clearinghouse by which users can locate vendors as well as a clearing house or referral source by which vendors can identify and communicate with users or prospective customers or clients.

The central processing computer can also function as an interactive message handling facility for processing and storing any messages, e-mail messages, instant messaging services messages, and/or any other electronic and/or other messages or transmissions, which can be utilized in order to facilitate communications by and between any of the herein described users or vendors.

The central processing computer can also record and store any information regarding any transactions which can be processed by the apparatus for later use in marketing activities, advertisement and promotional activities, and/or for any other appropriate purpose(s).

The apparatus and method of the present invention can also be utilized in order to generate and/or to transmit promotional messages and/or advertisement messages in the form of e-mail messages, electronic transmissions, instant messaging service messages, telephone messages, letter mail deliveries, telephone transmissions, facsimile transmissions, beeper or pager messages, and/or via any other notification means or method, and store same for the respective user(s) at the respective vendor computer or merchant computer. The e-mail messages, electronic transmissions, instant messaging service messages, telephone messages, letter mail deliveries, telephone transmissions, facsimile transmissions, beeper or pager messages, and/or via any other notification means, can contain text materials, video materials, video clips, audio materials, audio clips, audio/video materials, audio/video clips, infomercials, and/or any combination of same.

A user can, at any time, access the respective vendor computer or merchant computer via his or her respective user communication device over the communication network and retrieve any of the respective messages. The user can also access the vendor computer or merchant computer via the central processing computer in order to access and retrieve his or her messages. The respective vendor computer or the merchant computer, or the central processing computer can notify the user that a message(s) has been sent to him or her.

Any of the herein-described e-mail messages, instant messaging services messages, beeper messages, pager messages, facsimile messages, telephone call messages, pre-recorded telephone call messages, and/or other messages, can contain any one or more of text materials, video materials, video clips, audio materials, audio clips, audio/video materials, audio/video clips, infomercials, and/or any combination of same.

The information contained in the respective messages can be presented to the user on the respective user communication device in accordance with the capability of the respective user communication device.

Accordingly, it is an object of the present invention to provide an apparatus and method for processing transaction information.

It is another object of the present invention to provide an apparatus and method for processing transaction information in a network environment.

It is still another object of the present invention to provide an apparatus and method for processing transaction information which can be utilized to process a transaction in a wireless communication network.

It is yet another object of the present invention to provide an apparatus and method for processing transaction information in a line-wired communication network.

It is another object of the present invention to provide an apparatus and method for processing transaction information which can also be utilized in conjunction with the Internet and/or the World Wide Web.

It is still another object of the present invention to provide an apparatus and method for processing transaction information which can be utilized to facilitate wireless commerce and/or mobile commerce.

It is yet another object of the present invention to provide an apparatus and method for processing transaction information which can be utilized in facilitating and/or effectuating commerce in or regarding any goods, products, and/or services, which can be the subject matter of a transaction and/or a commercial transaction.

It is another object of the present invention to provide an apparatus and method for processing transaction information which can be utilized in conducting financial transactions and/or investment transactions involving securities, stocks, bonds, commodities, and/or any financial and/or commodities derivatives, options, futures, forwards, and/or other contracts.

It is still another object of the present invention to provide an apparatus and method for processing transaction information which can provide any one or more of a description of a good(s), a product(s), and/or a service(s), or a price or prices for the respective good(s), product(s), and/or service(s).

It is yet another object of the present invention to provide an apparatus and method for processing transaction information which can provide any one or more of a video image(s), and a video clip, of, or regarding, the a good(s), product(s), and/or service(s).

It is another object of the present invention to provide an apparatus and method for processing transaction information which can provide audio information for, or regarding, a respective good(s), product(s), and/or service(s).

It is still another object of the present invention to provide an apparatus and method for processing transaction information which can provide any one or more of shipping, handling, and/or delivery, information and/or charges or costs.

It is yet another object of the present invention to provide an apparatus and method for processing transaction information which can process and/or consummate a transaction.

It is another object of the present invention to provide an apparatus and method for processing transaction information which can generate a transaction confirmation message which can contain information regarding a transaction.

It is still another object of the present invention to provide an apparatus and method for processing transaction information which can notify a user regarding a transaction message and/or a transaction confirmation message.

It is yet another object of the present invention to provide an apparatus and method for processing transaction information which can facilitate voice communication between a user and a vendor during the use of same.

It is another object of the present invention to provide an apparatus and method for processing transaction information which can facilitate voice communication between a user and a vendor during the use of same, in real-time and/or otherwise.

It is still another object of the present invention to provide an apparatus and method for processing transaction information which can store information regarding an information request and/or information regarding a transaction in progress until such time as the vendor or the vendor's representative can respond to a user request for information.

It is yet another object of the present invention to provide an apparatus and method for processing transaction information which can generate a transaction confirmation message which can contain links or hyperlinks to another party and/or to an information source.

It is another object of the present invention to provide an apparatus and method for processing transaction information which can record and/or store information regarding any number of transactions.

It is still another object of the present invention to provide an apparatus and method for processing transaction information which can provide an interactive message handling facility.

It is yet another object of the present invention to provide an apparatus and method for processing transaction information which can provide an interactive mailbox facility.

It is another object of the present invention to provide an apparatus and method for processing transaction information which can provide a transaction clearinghouse facility.

It is still another object of the present invention to provide an apparatus and method for processing transaction information which can be utilized to generate and/or transmit promotional messages and/or advertisement messages.

It is yet another object of the present invention to provide an apparatus and method for processing transaction information which can be utilized to generate and/or transmit promotional messages and/or advertisement messages, which can contain any one or more of text material, video material, and audio material, and/or any combination of same.

It is another object of the present invention to provide an apparatus and method for processing transaction information which can present information to the user in accordance with the capability of the respective user communication device.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the drawings:

FIG. 1 illustrates the apparatus of the present invention, in block diagram form;

FIG. 2 illustrates the vendor computer of the apparatus of FIG. 1, in block diagram form;

FIG. 3 illustrates the central processing computer of the apparatus of FIG. 1, in block diagram form;

FIG. 4 illustrates the user communication device of the apparatus of FIG. 1, in block diagram form; and

FIGS. 5A and 5B illustrate a preferred embodiment method for utilizing the apparatus of FIG. 1, in flow diagram form.

### DESCRIPTION OF THE PREFERRED EMBODIMENTS

The present invention pertains to an apparatus and method for processing transaction information and in particular to an apparatus and method for processing transaction information in a network environment. The apparatus and method of the present invention can be utilized to process a transaction in any communication network environment, in a wireless communication network, in a line-wired communication network, and/or in any combination of wireless and wired networks. The present invention can also be utilized in conjunction with the Internet and/or the World Wide Web.

The present invention can be utilized for facilitating commerce involving wireless communication, wired communications, and/or mobile commerce (M-commerce).

The present invention can be utilized in facilitating and/or effectuating commerce in or regarding any goods, products, and/or services, which can be the subject matter of a transaction and/or a commercial transaction. The apparatus and method of the present invention can also be utilized in conducting financial transactions and/or investment transactions involving securities, stocks, bonds, commodities, and/or any financial and/or commodities derivatives, options, futures, forwards, and/or other contracts.

Applicant hereby incorporates by reference herein the subject matter and teachings of U.S. Provisional Patent Application Ser. No. 60/250,076 which teaches and discloses an apparatus and method for processing transaction information.

Applicant also hereby incorporates by reference herein the subject matter and teachings of U.S. Pat. No. 5,724,092 which teaches and discloses a videophone interactive mailbox facility system and method of processing information. Applicant also hereby incorporates by reference herein the subject matter and teachings of U.S. Pat. No. 5,606,361 which teaches and discloses a videophone interactive mailbox facility system and method of processing information.

In a preferred embodiment, the present invention can be utilized for processing transaction information for or involving any goods, products, and/or services which can be the subject matter of a transaction and/or a commercial transaction.

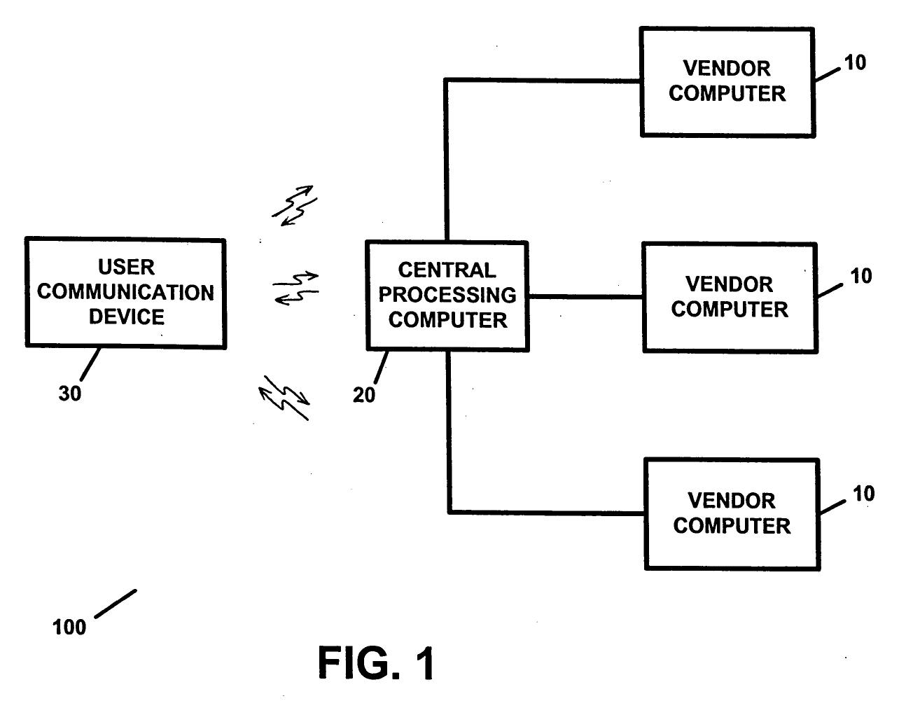

FIG. 1 illustrates a block diagram of a preferred embodiment of the apparatus of the present invention which designated generally by the reference numeral 100, in block diagram form.

With reference to FIG. 1, the apparatus includes one or more vendor computer(s) or merchant computer(s) 10 (hereinafter referred to as the “vendor computer 10” of “vendor computers 10”). The vendor computer(s) 10 can be associated with any one or any number of vendors or merchants for facilitating the sale or trade of any of the goods, products, and/or services, described herein as being sold and/or traded via the apparatus and method of the present invention.

The vendor computer(s) 10 can be any computer or computer system for processing transaction information regarding transactions involving and/or related to any of the goods, products, and/or services, described herein as being sold or traded via the apparatus and method of the present invention. The vendor computer 10 can also be any suitable computer, network computer, server computer, or computer system, for providing any of the transaction processing and/or functionality described herein.

The vendor computer 10 can also be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the user communication device 30 to communicate with and/or to interact with the central processing computer(s) 20 and/or any of the other computers or communication devices described herein.

Each vendor computer 10 can be utilized to transmit information to, and receive information from, any of the herein-described computers of communication devices.

In the preferred embodiment, any number of vendor computers 10 can be utilized in order to provide the processing and/or servicing functions described herein. The vendor computer(s) 10 may be linked to other vendor computers or may be stand alone devices.

Each vendor computer 10 may be a network computer, a personal computer, and/or any other communication device, suitable for allowing the vendor computer 10 to communicate with and/or to interact with any other vendor computer(s) 10 and/or with any of the other computers or communication devices described herein.

A given central vendor computer 10 may service a particular vendor, group of vendors, type of vendors, geographic area, and/or any entity or group of entities. A vendor computer 10 may also be dedicated to service any one or group of the above described vendors or merchants.

The apparatus 100 can also include a central processing computer or server computer 20 (hereinafter referred to as “central processing computer 20”). The central processing computer 20 can provide control over the apparatus 100 and performs various processing operations for providing any of the various services described herein. The central processing computer 20 can also provide various services and/or functionality for or regarding any of the vendors, merchants, or users of the apparatus and method of the present invention.

The central processing computer 20, in the preferred embodiment, can be any suitable computer, network computer, or computer system, for providing service for the various vendors, merchants and/or users of the apparatus and method of the present invention and/or any of the respective computers and/or communication devices associated therewith.

In the preferred embodiment, any number of central processing computers 20 can be utilized in order to provide the processing and/or servicing functions described herein. The central processing computer(s) 20 may be linked to other central processing computers or may be stand alone devices.

Each central processing computer 20 may be a network computer, a personal computer, and/or any other communication device, suitable for allowing the central processing computer 20 to communicate with and/or to interact with any other vendor computer(s) 10 and/or with any of the other computers or communication devices described herein.

A given central processing computer 20 may service a particular vendor, group of vendors, user, group of users, geographic area, and/or any entity or group of entities. A central processing computer 20 can also be utilized by a vendor, a merchant, or a user.

A central processing computer 20 may also be dedicated to service any one or group of the above described individuals and/or entities.

The apparatus 100, in the preferred embodiment, also includes one or more user computers or user communication devices 30 (hereinafter referred to as “user communication device 30” or “user communication devices 30”) with each user communication device 30 being associated with a user, individual, or group of users or individuals. Any user communication device 30 may also be associated with a number of users and/or individuals, depending upon the application. The user communication device 30 can be utilized by any user, individual, vendor, merchant, and/or any other third party desiring to utilize the apparatus 100.

Each user communication device 30 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the user communication device 30 to communicate with and/or to interact with any of the vendor computers 10, the central processing computer(s) 20, and/or any of the user computers 30 or communication devices described herein. Each user communication device 30 can be utilized to transmit information to, and receive information from, any of the vendor computer(s) 10, central processing computers 20, and/or any other user computers 30 described herein.

In the present invention, any number of user computers 30 may be utilized. In the present invention, each user, individual, or entity, utilizing the present invention may have one or more user computers 30 associated therewith.

Each of the vendor computer(s) 10, the central processing computer(s) 20, and/or the user computer(s) 30, can communicate and/or interact with any vendor computer(s) 10, the central processing computer(s) 20, and/or the user computer(s) 30.

The vendor computer(s) 10, the central processing computer(s) 20, and/or the user computer(s) 30, can communicate with each other via any suitable communication network or system.

In the preferred embodiment, the apparatus 100 can be utilized on, over, or in conjunction with, the Internet and/or the World Wide Web. The apparatus 100 can also be utilized on, over, or in conjunction with, any appropriate communication networks or systems including, but not limited to, network communication systems, telephone communication networks or systems, wired or line connected communication networks or systems, wireless communications networks or systems, cellular communication networks or systems, digital communication networks or systems, personal communication networks or systems, personal communication services (PCS) networks or systems, satellite communication networks or systems, broad band communication networks or systems, bluetooth communications networks or systems, low earth orbiting (LEO) satellite networks or systems, and/or public switched telephone networks or systems.

The apparatus and method of the present invention can be utilized on, over, and/or in conjunction with, a wireless communication network or system, a wired or line-connected communication network or system, or any combination of a wireless communication network or system and a wired or line-connected communication network or system.

The present invention, in the preferred embodiment, can also utilize wireless Internet and/or World Wide Web services, equipment and/or devices. Any of the vendor computer(s) 10, the central processing computer(s) 20, and/or the user computer(s) 30, in the preferred embodiment, can have a web site or web sites associated therewith.

In the preferred embodiment, each of the vendor computer(s) 10, the central processing computer(s) 20, and/or the user computer(s) 30, can be equipped with any and/or all hardware and/or software necessary and/or desirable for facilitating the operation of the apparatus 100 as described herein.

In the preferred embodiment, each of the vendor computer(s) 10, the central processing computer(s) 20, and/or the user computer(s) 30, can transmit and/or receive data and/or information using TCP/IP, as well as any other Internet and/or World Wide Web, protocols, including wireless protocols as well as non-wireless protocols.

The vendor computer(s) 10, the central processing computer(s) 20, and/or the user computer(s) 30, in the preferred embodiment, can be linked directly or indirectly with any other vendor computer(s) 10, the central processing computer(s) 20, and/or the user computer(s) 30. Any of the herein-described computers may communicate with any other computer in a bi-directional manner.

In any and/or all of the embodiments described herein, any of the computer to computer communications, and/or any of the communications which can occur between any of the herein-described individuals and/or entities and/or their respective computers, can be made and/or can be effected by an e-mail transmission, an e-mail message, an electronic transmission, an instant messaging service message, a telephone message, a letter mail delivery, a telephone transmission, a facsimile transmission, a beeper or a pager message, and/or via any other notification means or method. Any and/or all of the communications which can occur between any of the herein-described computers and/or the individuals and/or entities associated therewith can contain text information, video information, audio information, audio/video information, and/or any combination of same.

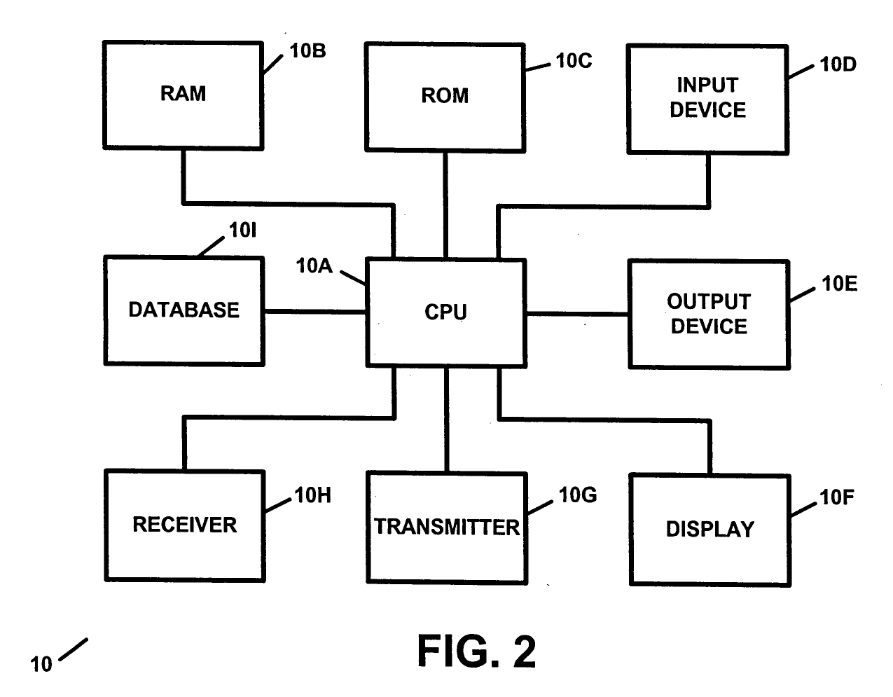

FIG. 2 illustrates the vendor computer 10, in block diagram form. In the preferred embodiment, the vendor computer 10 includes a central processing unit or CPU 10A, which in the preferred embodiment, is a microprocessor. The CPU 10A can also be a microcomputer, a minicomputer, a macro-computer, and/or a mainframe computer, depending upon the application.

The vendor computer 10 also includes a random access memory device(s) 10B (RAM) and a read only memory device(s) 10C (ROM), each of which is connected to the CPU 10A, a user input device 10D, for entering data and/or commands into the vendor computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The vendor computer 10 also includes a display device 10E for displaying data and/or information to a user or operator.

The vendor computer 10 also includes a transmitter(s) 10F, for transmitting signals and/or data and/or information to any one or more of the central processing computer(s) 20, and/or the user computers 30, which may be utilized in conjunction with the present invention.

The vendor computer 10 also includes a receiver 10G, for receiving signals and/or data and/or information from any one or more of the central processing computer(s) 20 and/or the user computers 30, which may be utilized in conjunction with the present invention.

The vendor computer 10 can also include a database 10H. The database 10H can contain data and/or information regarding the vendor or merchant, including but not limited to the respective vendor's or merchant's name, address, telephone number, beeper number, pager number, facsimile number, e-mail address, server address, domain name(s), uniform resource locator(s) URL(s), and/or any other contact information. The database 10H can also contain information regarding the respective vendor or merchant along with information regarding the respective goods, products, and/or services, which the vendor or merchant provides and/or offers for sale or trade.

The database 10H can also contain data and/or information regarding the respective goods, products, and/or services, which are provided by the respective vendor or merchant, descriptions of the respective goods, products, and/or services, prices for the respective goods, products, and/or services, promotional information and/or materials, advertisement information and/or materials, and/or any other information and/or materials, regarding and/or relating to the respective goods, products, and/or services. The promotional information and/or materials and/or the advertisement materials information and/or materials, can include text materials, video materials, video clips, audio materials, audio clips, audio/video materials, audio/video clips, infomercials, and/or any combination of same.

The database 10H can also contain any other data and/or information regarding and/or related to the respective goods, products, and/or services, provided by and/or offered by the vendor or merchant for facilitating the selling, trading, wholesale selling, retail selling, e-tailing, and/or electronic commerce, of any of the vendor's or merchant's respective goods, products, and/or services.

The database 10H can also contain data and/or information regarding customers and/or clients of the vendor or merchant, including but not limited to, the name(s), address or addresses, beeper number(s), pager number(s), (s), facsimile number(s), e-mail address or e-mail addresses, and/or any other contact information for or regarding any of the users, customers, clients, prospective users, prospective customers, and/or prospective clients, of the vendor or merchant and/or for any of the users of the apparatus and method of the present invention. The database 10H can also contain any data and/or information regarding a credit account or credit card account, a debit account or debit card account, a charge account or charge card account, a bank account, a checking account, a savings account, an electronic money account, an electronic funds transfer account, and/or any other financial account, of any of the herein-described users, customers, clients, prospective users, prospective customers, and/or prospective clients, of the apparatus and method of the present invention.

The database 10H can also contain any data and/or information for conducting transactions for or involving any of the vendor's or merchant's respective goods, products, and/or services. The database 10H can contain any data and/or information for generating order forms or ordering materials, sales forms or sales materials, sales receipts, packing slips, shipping forms, shipping materials, order confirmation forms, order confirmation materials, and/or billing forms or billing materials. The database 10H can also contain any other data and/or information which can be utilized in conducting transactions and/or business transactions of any type or kind.

The vendor computer 10 also includes a database(s) 10H which can contain any of other data and/or information for facilitating the operation of the vendor computer 10 as described herein.

With reference once again to FIG. 2, the vendor computer 10 also includes an output device 10I such as a printer, a modem, a fax/modem, or other output device, for providing data and/or information to the operator or user of vendor computer 10 or to a third party or third party entity.

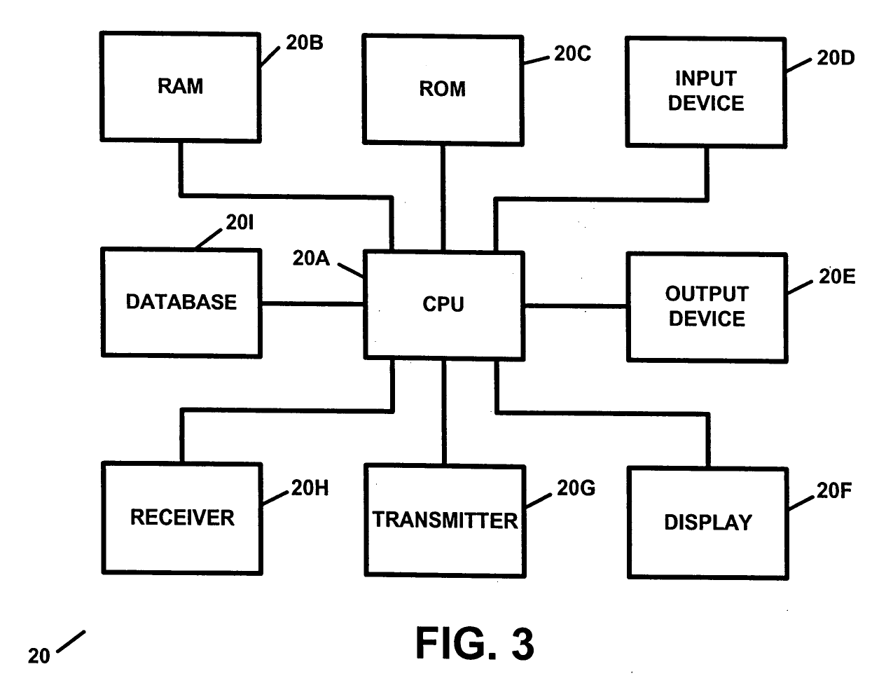

FIG. 3 illustrates the central processing computer 20, in block diagram form. The central processing computer 20, in the preferred embodiment, is a network computer or computer system which is utilized as a central processing computer such as an Internet server computer and/or a web site server computer. In the preferred embodiment, the central processing computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The central processing computer 20 also includes a random access memory device(s) 20B (RAM) and a read only memory device(s) 20C (ROM), each of which is connected to the CPU 20A, a user input device 20D, for entering data and/or commands into the central processing computer 20, which includes any one or more of a keyboard, a scanner, a user pointing device, such as, for example, a mouse, a touch pad, and/or an audio input device and/or a video input device, etc., if desired, which input device(s) is also connected to the CPU 20A. The central processing computer 20 also includes a display device 20E for displaying data and/or information to a user or operator.

The central processing computer 20 also includes a transmitter(s) 20F, for transmitting signals, data and/or information to any one or more of the vendor computers 10, the user computers, and/or any of the other central processing computers 20, which may be utilized in conjunction with the present invention. The central processing computer 20 also includes a receiver 20G, for receiving signals, data and/or information from any one or more of the vendor computers 10, the user computers, and/or any of the other central processing computers 20, which may be utilized in conjunction with the present invention.

The central processing computer 10 also includes a database 20H. The database 20H can contain any and/or all of the data and/or information described herein-above as being contained in the database(s) 10H of any and/or all of the vendor computer(s) 10 utilized in conjunction with the present invention. The database 20H can also contain any and/or all of the data and/or information described herein-below as being contained in the database(s) 30H of any and/or all of the user computer(s) 30 utilized in conjunction with the present invention. In this manner, the database 20H can contain any and/or all of the data and/or information which may be needed and/or desired for processing any of the data and/or information, including transaction data and/or information, transaction processing data and/or information, and/or any other related and/or ancillary data and/or information processing which can be processed in the use of the present invention in any of the embodiments described herein.

In this manner, the database 20H can contain data and/or information regarding the vendor or merchant, including but not limited to the respective vendor's or merchant's name, address, telephone number, beeper number, pager number, facsimile number, e-mail address, server address, domain name(s), uniform resource locator(s) URL(s), and/or any other contact information. The database 20H can also contain information regarding the respective vendor or merchant along with information regarding the respective goods, products, and/or services, which the vendor or merchant provides and/or offers for sale or trade.

The database 20H can also contain data and/or information regarding the respective goods, products, and/or services, which are provided by the respective vendor or merchant, descriptions of the respective goods, products, and/or services, prices for the respective goods, products, and/or services, promotional information and/or materials, advertisement information and/or materials, and/or any other information and/or materials, regarding and/or relating to the respective goods, products, and/or services. The promotional information and/or materials and/or the advertisement materials information and/or materials, can include text materials, video materials, video clips, audio materials, audio clips, audio/video materials, audio/video clips, infomercials, and/or any combination of same.

The database 20H can also contain any other data and/or information regarding and/or related to the respective goods, products, and/or services, provided by and/or offered by the vendor or merchant for facilitating the selling, trading, wholesale selling, retail selling, e-tailing, and/or electronic commerce, of any of the vendor's or merchant's respective goods, products, and/or services.

The database 20H can also contain data and/or information regarding customers and/or clients of the vendor or merchant, as well as information regarding any customers and/or clients which utilized the apparatus 100 of the present invention, including but not limited to, the name(s), address or addresses, beeper number(s), pager number(s), (s), facsimile number(s), e-mail address or e-mail addresses, and/or any other contact information for or regarding any of the users, customers, clients, prospective users, prospective customers, and/or prospective clients, of the vendor or merchant and/or for any of the users of the apparatus and method of the present invention.

The database 20H can also contain any data and/or information regarding a credit account or credit card account, a debit account or debit card account, a charge account or charge card account, a bank account, a checking account, a savings account, an electronic money account, an electronic funds transfer account, and/or any other financial account, of any of the herein-described users, customers, clients, prospective users, prospective customers, and/or prospective clients, of the apparatus and method of the present invention.

The database 20H can also contain any data and/or information for conducting transactions for or involving any of the vendor's or merchant's respective goods, products, and/or services. The database 10H can contain any data and/or information for generating order forms or ordering materials, sales forms or sales materials, sales receipts, packing slips, shipping forms, shipping materials, order confirmation forms, order confirmation materials, and/or billing forms or billing materials. The database 20H can also contain any other data and/or information which can be utilized in conducting transactions and/or business transactions of any type or kind.

The database(s) 20H can also contain any of other data and/or information for facilitating the operation of the central processing computer 20 as described herein.

With reference once again to FIG. 3, the central processing computer 20 also includes an output device 20I such as a printer, a modem, a fax/modem, or other output device, for providing data and/or information to the operator or user of the central processing computer 20 or to a third party or third party entity.

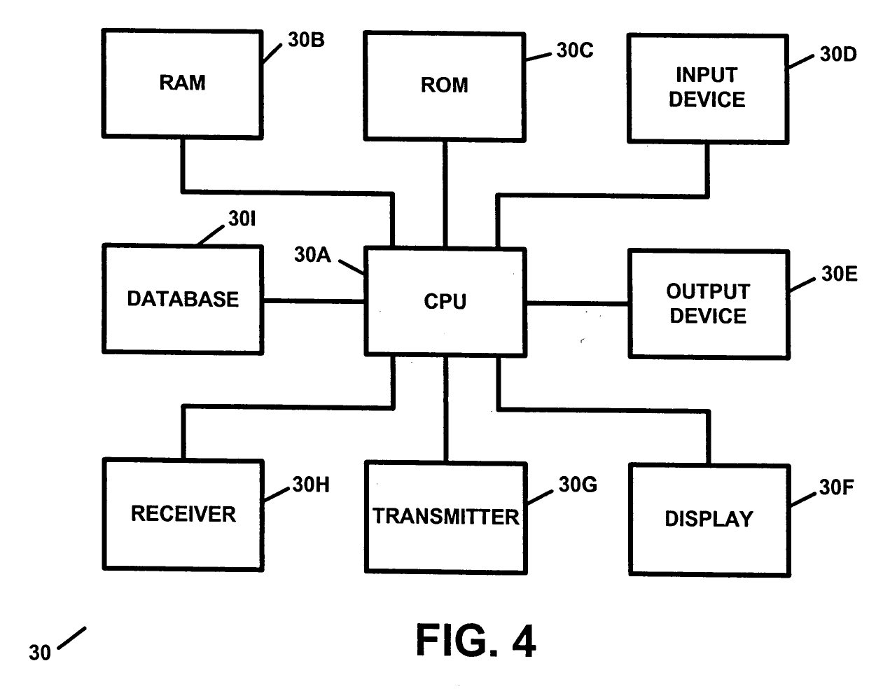

FIG. 4 illustrates the user communication device 30, in block diagram form. In the preferred embodiment, the user communication device 30 includes a central processing unit or CPU 30A, which in the preferred embodiment, is a microprocessor. The CPU 30A can also be a microcomputer, a minicomputer, a macro-computer, and/or a mainframe computer, depending upon the application.

The user communication device 30 also includes a random access memory device(s) 30B (RAM) and a read only memory device(s) 30C (ROM), each of which is connected to the CPU 30A, a user input device 30D, for entering data and/or commands into the user communication device 30, which includes any one or more of a keyboard, a scanner, a user pointing device, such as, for example, a mouse, a touch pad, and/or an audio input device and/or a video input device, etc., if desired, which input device(s) is also connected to the CPU 30A. The user communication device 30 also includes a display device 30E for displaying data and/or information to a user or operator.

The user communication device 30 also includes a transmitter(s) 30F, for transmitting signals and/or data and/or information to any one or more of the vendor computers 10 and/or central processing computer(s) 20, which may be utilized in conjunction with the present invention.

The user communication device 30 also includes a receiver 30G, for receiving signals and/or data and/or information from any one or more of the vendor computers 10 and/or the central processing computer(s) 20, which may be utilized in conjunction with the present invention.

The user communication device 30 also includes a database(s) 30H which can contain any of the data and/or information described herein as being stored in the database 10H of the vendor computer 10. The database 30H can contain data and/or information regarding any of the vendors or merchants described herein, such as the name(s), address or addresses, telephone number(s), beeper number(s), pager number(s), facsimile number(s), e-mail address or e-mail addresses, server address or server addresses, domain name(s), URL(s), and/or any other contact information.

The database 30H can also contain information regarding the respective vendor or merchant along with information regarding the respective goods, products, and/or services, which the vendor or merchant provides and/or offers for sale or trade.

The database 30 can also contain data and/or information regarding the user or users associated with the user communication device 30, such as, but not limited to, user name(s), address or addresses, telephone number(s), beeper number(s), pager number(s), facsimile number(s), e-mail address or e-mail addresses, and/or any other contact information for or regarding the user or users. The database 30H can also contain any data and/or information regarding the credit account(s) or credit card account(s), a debit account(s) or debit card account(s), a charge account(s) or charge card account(s), a bank account(s), a checking account(s), a savings account(s), an electronic money account (s), an electronic funds transfer account(s), and/or any other financial account(s), of the user or users.

The database 30H can also contain any other data and/or information for facilitating the operation of the user communication device as described herein.

With reference once again to FIG. 4, user communication device 30 also includes an output device 30I such as a printer, a modem, a fax/modem, or other output device, for providing data and/or information to the operator or user of the user communication device 30 or to a third party or third party entity.

The respective databases 10H, 20H, and/or 30H can also contain any other information which may be relevant, pertinent, useful, and/or desired, for facilitating the operation of the apparatus and method of the present invention as described herein and/or as related thereto. The respective databases 10H, 20H, and/or 30H can include individual databases or collections of databases, with each database being designated to store any and/or all of the data and/or information described herein.

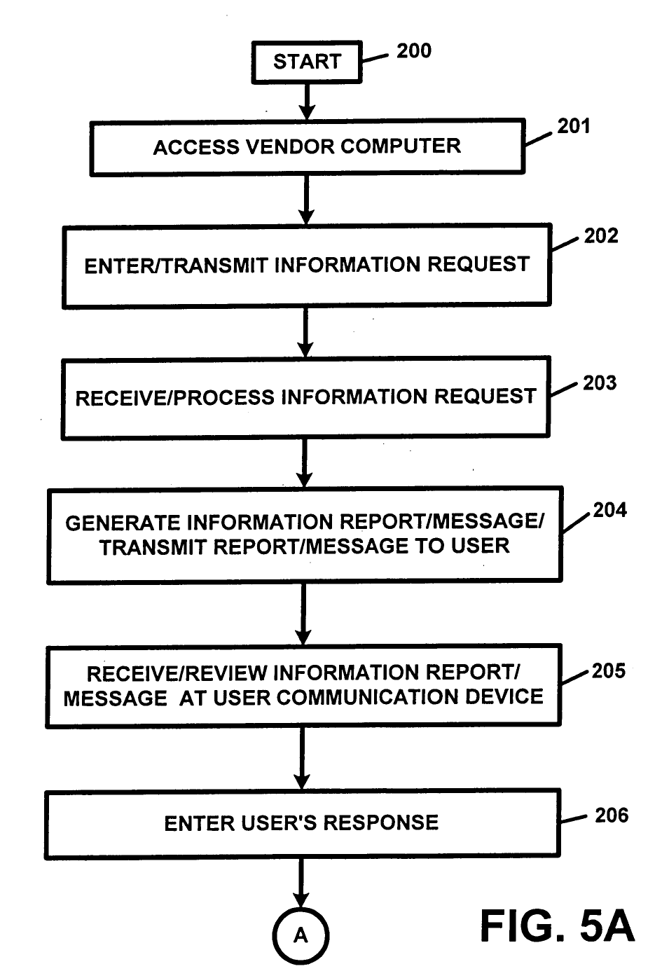

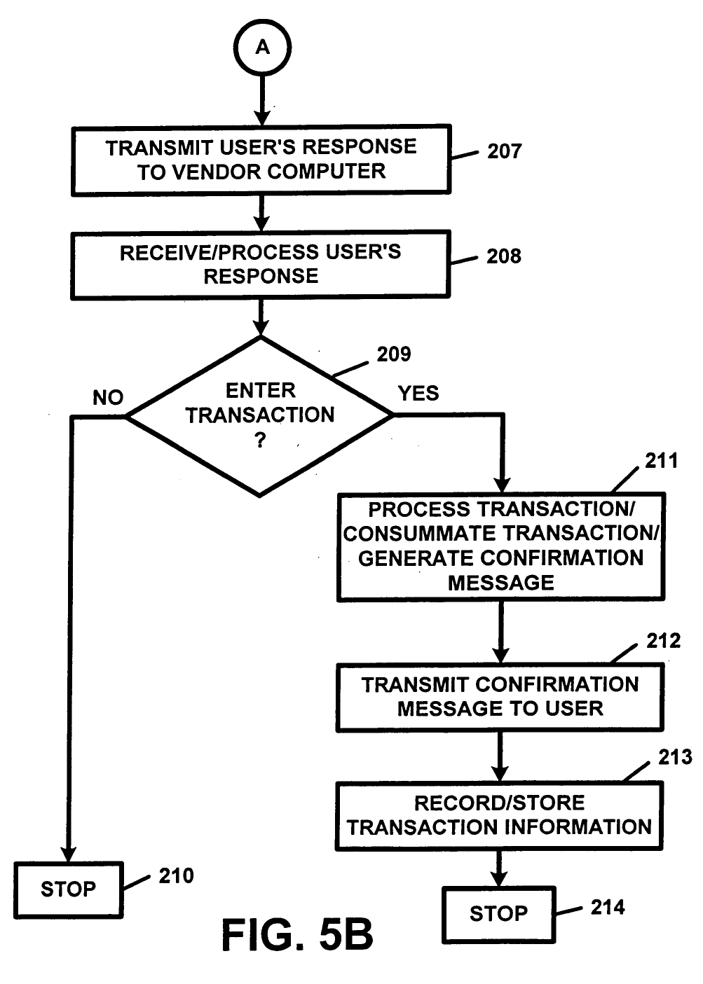

In a preferred embodiment, the apparatus 100 of the present invention can be utilized in order to conduct transactions in a network environment. FIGS. 5A and 5B illustrate a method of utilizing the apparatus and method of the present invention to conduct transactions involving any goods, products, or services, which can be the subject matter of commerce. The embodiment of FIGS. 5A and 5B can also be utilized in order conduct can also be utilized in conducting financial transactions and/or investment transactions involving securities, stocks, bonds, commodities, and/or any financial and/or commodities derivatives, options, futures, forwards, and/or other contracts.

The preferred embodiment of FIGS. 5A and 5B is described as being utilized in connection with a user communication device 30 which is a video telephone or a videophone. The video telephone or videophone can be a wireless device or a line-connected device. The use of a wireless video telephone or videophone can facilitate wireless transactions and/or mobile transactions as well as provide multimedia content which can include text information, video information, audio information, audio/visual information, and/or any combination of same. The use of a video telephone or a videophone can also facilitate voice communications between parties to a transaction or parties to a communication. The voice communications can take place at any time during a transaction and/or during use of the user communication device 30.

Although the preferred embodiment of FIGS. 5A and 5B is described as being utilized in conjunction with a video telephone or videophone as the user communication device 20, it is to be understood that the preferred embodiment of FIGS. 5A and 5B can also be utilized in conjunction with a user communication device 30 which can be any one of more of a personal computer, a hand-held computer, a palmtop computer, a laptop computer, a personal communication device, a personal digital assistant, a telephone, a digital telephone, a display telephone, a 3G telephone, a cellular telephone, a wireless telephone, a television, an interactive television, a beeper, a pager, a watch, a network computer, a server computer, and/or any other communication device.

The operation of the apparatus 100 commences at step 200. At step 201, a user can access the vendor computer 10 of the vendor with whom he or she desires to engage in a transaction. The user can access the vendor computer via his or her user communication device 30. At step 202, the user can enter an information request regarding the respective good(s), product(s), and/or service(s), which the user desires to either purchase, lease, and/or otherwise obtain. At step 202, the information contained in the user's information request can be transmitted to the vendor computer 10.

At step 203, the vendor computer will receive and process the information contained in the user's information request. At step 204, the vendor computer 10 will generate an information report or message which can contain information regarding the requested good(s), product(s), and/or service(s) and/or which is otherwise responsive to the user's information request. At step 204, the vendor computer 10 will also transmit the information report or message to the user communication device 30 associated with the user.

The information report or message can include any one or more of a description of the respective good(s), product(s), and/or service(s), a price or prices for the respective good(s), product(s), and/or service(s), a video image(s) or video clip of or regarding the respective good(s), product(s), and/or service(s), audio information for or regarding the respective good(s), product(s), and/or service(s), and/or any applicable shipping, handling, and/or delivery, information and/or charges or costs.

The information report or message can also include any other data and/or information which can be related to the respective good(s), product(s), and/or service(s), and/or information regarding any transactions involving any of the respective good(s), product(s), and/or service(s), or prospective transactions which may involve any of the respective good(s), product(s), and/or service(s).

At step 205, the user can receive and review the information contained in the information report or message on his or her respective user communication device 30. At step 205, the user can decide whether to engage in a transaction, a purchase, or a lease, involving any of the respective good(s), product(s), and/or service(s). The user can then, at step 206, either enter a response which can include information regarding the user's decision to enter into a transaction or to decline to enter into a transaction. The information contained in the user's response can then be transmitted to the vendor computer 10 at step 207.

At step 208, the vendor computer 10 can receive the user's response. At step 209, the vendor computer can determine if the user decided to enter into a transaction, to make a purchase, or to enter into a lease, regarding any of the respective good(s), product(s), and/or service(s). If, at step 209, the vendor computer 10 determines that the user does not desire to enter into a transaction, then the operation of the apparatus 100 and/or the vendor computer 10 will cease at step 210.

If, however, at step 209, the vendor computer 10 determines that the user desires to enter into a transaction, the vendor computer will proceed to step 211 and process the transaction. At step 211, the vendor computer 10 will process and/or consummate the transaction. At step 211, the vendor computer 10 can also generate any one or more of an electronic mail (e-mail) transaction confirmation message or an instant messaging transaction confirmation message which will contain information regarding the transaction which has taken place.

The transaction confirmation message(s) can contain details regarding the transaction, the amount(s) or total amount of the transaction, delivery and/or shipment information, and information regarding any due balance(s). At step 211, instead of or in addition to an e-mail message or an instant messaging message, the vendor computer 10 can generate a telephone call, a telephone call with a pre-recorded message, a beeper message, a pager message, a facsimile message, and/or any other appropriate message or communication, electronic message, and/or electronic transmission.

At step 212, any one or more of the respective e-mail message, instant messaging message, telephone call, telephone call with a pre-recorded message, beeper message, pager message, facsimile message, and/or any other appropriate message or communication, electronic message, and/or electronic transmission, can be transmitted to the user communication device 30.

At step 212, the vendor computer can also notify the user that any one or more of the above e-mail message, instant messaging message, telephone call, telephone call with a pre-recorded message, beeper message, pager message, facsimile message, and/or any other appropriate message or communication, electronic message, and/or electronic transmission, has been sent to the user.

For example, the vendor computer 10 can telephone the user, can telephone the user with a pre-recorded message, can send a beeper message to the user, can send a facsimile message to the user, can send a pager message to the user, and/or can send an instant messaging message to the user, notifying the user that any of the herein-described transaction confirmation messages have been sent or transmitted to the user in any of the herein-described forms. For example, the vendor computer 10 can transmit a beeper message or pager message to the user notifying the user that an e-mail containing a transaction confirmation message has been transmitted to him or her and/or is available for review by the user.

The transaction confirmation message can also contain links or hyperlinks for enabling the user to interact with the message and/or its sender. For example, the transaction confirmation message containing balance due information can contain a link to the billing department of the vendor. The user can link to the billing department in order to effect payment of the outstanding balance such as by credit card payment, by charge card payment, by debit card payment, by electronic funds transfer, and/or by any other appropriate method.

At any time during the operation of the preferred embodiment of FIGS. 5A and 5B, the user can utilize the respective user communication device 30, described as being a video telephone or videophone in the preferred embodiment, in order to communicate with a vendor's representative, in real-time. The user can also communicate with the vendor by leaving a voice mail message for the vendor or a vendor's representative via the video telephone or videophone. The vendor or the vendor's representative can then call the user back in response to the message.

In this manner, the apparatus and method of the present invention can allow a user to communicate with the vendor during the operation of the embodiment of FIGS. 5A and 5B such as, for example, in order to obtain information and/or customer service information from the vendor.

If the vendor or the vendor's representative is unavailable, the vendor computer 10 can store all information regarding the information request and/or information regarding the transaction in progress until such time as the vendor or the vendor's representative can return the user's call or respond to the user's message. The vendor's representative can then call the user back at the user communication device 30 and have all of the information to-date regarding the transaction, and/or the transaction in progress, available in order to facilitate picking-up the transaction at the point where the user needed or requested the information.

In another preferred embodiment, payment information and/or any other instructions and/or communications, between the user and the vendor computer 10 can be effected by any one or more of e-mail messages, instant messaging messages, and/or any other electronic and/or other messages. For example, payment information can be transmitted form the user to the vendor computer 10 via an e-mail message, an instant messaging services message, and/or any electronic transmission.

The vendor computer 10 can, at step 213, can record and store any information regarding the transaction for later use by the vendor in its markets activities, advertisement and promotional activities, and/or for any other appropriate manner.

The operation of the apparatus 100 will thereafter cease at step 214.

In the preferred embodiment, the vendor computer 10 will also function as an interactive message handling facility for processing and storing any messages, e-mail messages, instant messaging messages, and/or any other electronic and/or other messages or transmissions, which can be utilized in order to facilitate communications by and between any of the herein described users or vendors.

The vendor computer 10 can also include any hardware and/or software needed and/or desired for providing and/or for effectuating the interactive message handling facility and/or the interactive mailbox facility. In another preferred embodiment, the vendor computer 10 can also function as an interactive mailbox facility for any of the messages sent between any of the respective parties.

The vendor computer(s) or merchant computer(s) can also include, and/or be linked to, any other computer, computer system, server computer, e-mail server computer, and/or message server computer, in order to provide the herein-described message handling facility and/or interactive mailbox facility.

In any and/or all of the embodiments described herein, any and/or all of the communications, transmissions and/or messages, which are described as taking place between the user communication device 30 and the vendor computer 10 can be transmitted over an communication network from the respective transmitting computer directly to the respective receiving computer. In this regard, none of the respective communications, transmissions and/or messages, have to be transmitted or received via the central processing computer 10.

In another preferred embodiment, any of the herein described communications, transmissions and/or messages, can be transmitted or received via the central processing computer 20 which can serve as an intermediary between the respective parties. The central processing computer can also function as clearinghouse by which users can locate vendors as well as a clearing house or referral source by which vendors can identify and communicate with users or prospective customers or clients.

The central processing computer 10 will also function as an interactive message handling facility for processing and storing any messages, e-mail messages, instant messaging messages, and/or any other electronic and/or other messages or transmissions, which can be utilized in order to facilitate communications by and between any of the herein described users or vendors. The central processing computer 20 can also include the hardware and software needed and/or desired for effectuating the interactive message handling facility. In another preferred embodiment, the central processing computer 20 can also function as an interactive mailbox facility for any of the messages sent between any of the respective parties.

The central processing computer 20 can record and store any information regarding any transactions which can be processed by the apparatus 100 for later use in markets activities, advertisement and promotional activities, and/or for any other appropriate manner.

In another preferred embodiment, any of the vendors described herein as utilizing the present invention, can generate and/or transmit promotional messages and/or advertisement messages in the form e-mail messages, electronic transmissions, instant messaging service messages, telephone messages, letter mail deliveries, telephone transmissions, facsimile transmissions, beeper or pager messages, and/or via any other notification means or method, and store same for the respective user(s) at the respective vendor computer 10.

The promotional messages and/or advertisement messages can contain text materials, video materials, video clips, audio materials, audio clips, audio/video materials, audio/video clips, infomercials, and/or any combination of same.

A user can, at any time, access the vendor computer 10 via his or her respective user communication device 30 over the communication network and retrieve any message(s). The user can also access the vendor computer 10 via the central processing computer 20 in order to access and retrieve his or her message(s). In another preferred embodiment, the vendor computer 10 and/or the central processing computer 20 can notify the user that a message(s) has been sent to him or her.

In this embodiment, the vendor computer(s) 10 and/or the central processing computer(s) 20 can generate a beeper message, a pager message, a telephone call, a telephone call with a pre-recorder message, and/or an instant messaging message, and transmit same to the user communication device 30. In this manner, the apparatus 100 can notify a user when the user receives an e-mail message.

In any and/or all of the embodiments described herein, any of the e-mail messages, instant messaging services messages, beeper messages, pager messages, facsimile messages, telephone call messages, pre-recorded telephone call messages, and/or any other messages, can contain any one or more of text materials, video materials, video clips, audio materials, audio clips, audio/video materials, audio/video clips, infomercials, and/or any combination of same.

The information contained in the respective messages can be presented to the user on the respective user communication device 30 in accordance with the capabilities of the respective user communication device(s). For example, a user communication device 30 which is a computer or a video telephone can, when appropriately equipped (i.e. display/video screen, speakers, etc., can provide the user with any of the text materials, video material and audio materials which are provided in the respective e-mail message.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for processing a transaction, comprising:
a memory device for storing information regarding at least one of a good, a product, a service, a security, a stock, a bond, a commodity, a derivative, and information for processing a transaction involving said at least one of a good, a product, a service, a security, a stock, a bond, a commodity, and a derivative;
a receiver for receiving an information request from a communication device associated with a user, wherein said information request is a request for information regarding said at least one of a good, a product, a service, a security, a stock, a bond, a commodity, a derivative, and a transaction involving said at least one of a good, a product, a service, a security, a stock, a bond, a commodity, and a derivative;
a processor for processing said information request in conjunction with said information stored in said memory device, wherein said processor generates an information report containing information in response to said information request, and further wherein said information report contains video information; and
a transmitter for transmitting said information report to the communication device associated with the user.

2. The apparatus of claim 1, wherein the communication device is at least one of a video telephone and a videophone.

3. The apparatus of claim 1, wherein said receiver receives a user response containing information for entering into a transaction involving said at least one of a good, a product, a service, a security, a stock, a bond, a commodity, a derivative, and wherein said processor at least one of processes a transaction involving said at least one of a good, a product, a service, a security, a stock, a bond, a commodity, a derivative, and consummates a transaction involving said at least one of a good, a product, a service, a security, a stock, a bond, a commodity, a derivative.

4. The apparatus of claim 3, wherein said processor generates a transaction confirmation message, and further wherein said transmitter transmits said transaction confirmation message to the communication device associated with the user.

5. The apparatus of claim 1, wherein said apparatus is at least one of a computer, a server computer, a network computer, and a communication device.

6. The apparatus of claim 1, wherein the communication device is at least one of a personal computer, a hand-held computer, a palmtop computer, a laptop computer, a personal communication device, a personal digital assistant, a telephone, a digital telephone, a display telephone, a 3G telephone, a cellular telephone, a wireless telephone, a television, an interactive television, a beeper, a pager, a watch, a network computer, and a server computer.

7. The apparatus of claim 1, wherein said apparatus is utilized at least one of on and over a communication network, a telecommunication network, a wireless communication network, the Internet, and the World Wide Web.

8. The apparatus of claim 1, wherein said receiver receives a voice signal.

9. The apparatus of claim 1, wherein said at least one of said information request, said information report, said user response and said transaction confirmation message is at least one of an e-mail message, an electronic transmission, an instant messaging service message, a telephone message, a letter mail delivery, a telephone transmission, a facsimile transmission, a beeper message, and a pager message.

10. The apparatus of claim 1, wherein said information report contains at least one of text information and audio information.

11. The apparatus of claim 1, wherein said processor stores information regarding a transaction involving said at least one of a good, a product, a service, a security, a stock, a bond, a commodity, and a derivative.

12. The apparatus of claim 1, wherein at least one of said apparatus and said processor stores information regarding at least one of said information request, said information report, and a user response.

13. The apparatus of claim 1, wherein said processor generates at least one of a promotional message and an advertising message involving said at least one of a good, a product, a service, a security, a stock, a bond, a commodity, a derivative, for the user.

14. The apparatus of claim 13, wherein said at least one of a promotional message and an advertising message is stored for the user.

15. The apparatus of claim 14, wherein said processor generates a notification message notifying the user of the existence of at least one of said promotional message and said advertising message, wherein said notification message is at least one of an e-mail message, an electronic transmission, an instant messaging service message, a telephone message, a letter mail delivery, a telephone transmission, a facsimile transmission, a beeper message, and a pager message, and further wherein said transmitter transmits said notification message to the communication device associated with the user.

16. A method for processing a transaction, comprising:
storing information regarding at least one of a good, a product, a service, a security, a stock, a bond, a commodity, a derivative, and information for processing a transaction involving said at least one of a good, a product, a service, a security, a stock, a bond, a commodity, and a derivative;
receiving an information request from a communication device associated with a user, wherein said information request is a request for information regarding said at least one of a good, a product, a service, a security, a stock, a bond, a commodity, a derivative, and a transaction involving said at least one of a good, a product, a service, a security, a stock, a bond, a commodity, and a derivative;
processing said information request in conjunction with said stored information;
generating an information report containing information in response to said information request, wherein said information report contains video information; and
transmitting said information report to the communication device associated with the user.

17. An apparatus for processing a transaction, comprising:
a data entry device for inputting an information request containing a request for information regarding at least one of a good, a product, a service, a security, a stock, a bond, a commodity, a derivative;
a processor for processing said information request;
a transmitter for transmitting said information request to a vendor computer;
a receiver for receiving an information report from the vendor computer, wherein said information report contains video information regarding said at least one of at least one of a good, a product, a service, a security, a stock, a bond, a commodity, a derivative; and
a display device for displaying at least a portion of the information contained in said information report.

18. The apparatus of claim 17, wherein said apparatus is at least one of a video telephone and a videophone.

19. The apparatus of claim 17, wherein said transmitter transmits a user response containing information for entering into a transaction involving said at least one of a good, a product, a service, a security, a stock, a bond, a commodity, a derivative.

20. The apparatus of claim 17, wherein said receiver receives a transaction confirmation message.
